(19) United States
(12) Patent Application Publication
(10) Pub. No.: US 2008/0003332 A1
(43) Pub. Date: Jan. 3, 2008

(54) Multilayer heat shrinkable cook-in film

(76) Inventors: Dimitrios Ginossatis, Porto Rafti (GR); George Roussos, Dafne (GR)

Correspondence Address: JENKINS, WILSON, TAYLOR & HUNT, P. A., 3100 TOWER BLVD., Suite 1200, DURHAM, NC, 27707, US

(21) Appl. No.: 11/801,609

(22) Filed: May 10, 2007

(30) Foreign Application Priority Data
May 12, 2006 (EP) 06113872.3

(51) Int. Cl. B65D 85/00; A23L 1/00; B32B 27/06; B32B 27/32; B32B 27/34; B65B 53/02

(52) U.S. Cl. 426/106; 426/412; 428/34.9; 428/474.4; 428/515; 428/523

(57) ABSTRACT

The present invention is directed to a cook-in film and to bags, pouches and the like made therefrom. The invention is further directed to a method of producing and preserving a food product using such a film, bag or pouche and to a packaged food product obtained therefrom.

The present invention is directed to a cook-in film and to bags, pouches and the like made therefrom. The invention is further directed to a method of producing and preserving a food product using such a film, bag or pouche and to a packaged food product obtained therefrom.

Many food products are processed in thermoplastic film packages by subjecting the packed product to elevated temperatures produced by, for example, exposure to steam, hot air or immersion into boiling water. This thermal processing is usually called cook-in and the films used for such applications are generally called cook-in films.

A cook-in film must be capable of withstanding exposure to severe temperature conditions like immersion in hot water of temperature 70 to 90° C. for a time period of about 4 to 18 hours. During these severe thermal conditions, the film should be able to withstand
1. Opening of the seals
2. Delamination of the different layers of the multilayer structure.

A further desirable effect of the cook-in films is heat shrinkability, which is the ability of a film to shrink under heat conditions so that it conforms tightly to the packed food and gives a good aesthetic appearance.

A further desirable effect is good optical properties, meaning high gloss and low haze of the film, providing a nice presentation to the consumer.

Another desirable effect is the ability of the film to heat seal effectively in commercial bag making machines. The reason for this is that very often, the film is used in the form of a bag (pouch) in which the product is packed under vacuum and then is put in a hot water bath or in a steam container in order to be cooked.

Thus, it would be desirable to make a heat shrinkable film combining all these different requirements
1. Resistance to bag opening and delamination
2. High shrinkage
3. Excellent optics
4. Efficient heat sealability

It is also known in the art a similar process called post pasteurization. Many foods require pasteurization after being hermetically packed so that harmful microbes are destroyed. Specific pasteurization requirements may vary from country to country but 1 hour at 95° C. is considered a possible limiting case. The film of the invention may be used also to withstand these conditions.

### SUMMARY OF THE INVENTION

It is, therefore, an object of the present invention to provide a heat shrinkable multilayer film having excellent optics, efficient heat sealability, resistance to bag opening and delamination. It is a further object of the present invention to provide a cook-in film having the above properties.

These objects are achieved by the subject-matter of the independent claims. Preferred embodiments are set forth in the dependent claims.

The invention is based on the surprising insight that multilayer films for high temperature applications (up to about 95° C.; so called cook-in films) may be produced by introducing a heat sealing layer comprising a polypropylene polymer with a vicat softening point of less than 105° C. This is surprising since a skilled person having average knowledge in this field would expect those films to be unstable. In particular, a skilled person would expect opening of the seals and delaminating of the different layers of the multilayer structure, if a sealing layer comprising a polypropylene polymer with a vicat softening point of less than 105° C. is chosen.

However, it surprisingly turned out that the multilayer films of the present invention remained stable under these circumstances, i.e. did not show opening of the seals and delamination. Moreover, and even more unexpected, the multilayer film of the invention showed an improved heat sealability due to using an inner heat sealing layer having the above properties.

Thus, a very stable multilayer film for cook-in applications could be generated having improved characteristics regarding opening of the seals and delamination, but also regarding heat-shrinkability and optics.

Briefly the invention provides an oriented heat shrinkable film comprising a heat sealing layer comprising a polypropylene polymer, wherein both, the polypropylene and the overall sealing layer are having a vicat softening point of less than 105° C. The heat sealing layer is the inner layer. Other layers may include an oxygen barrier layer and an outer layer comprising polyolefin polymer or styrene butadiene copolymer.

The heat sealing layer may comprise a blend of the polypropylene polymer with other materials but the vicat softening point of the blend should be less than 105 C. The vicat softening point of a blend is calculated as follows:
Vb=x1*v1+x2*v2
where
Vb=softening point of the blend
V1=softening point of component 1
V2=softening point of component 2
X1=percentage per mass of component 1 in the blend
X2=percentage per mass of component 2 in the blend

The definitions used in the following are as follows:

The term “film” refers to a flat or tubular flexible structure of thermoplastic material. A “cook-in film” is more specifically defined as being a film adapted for high temperature applications, e.g. treatment with hot water at temperatures up to about 95° C.

The term “heat shrinkable” refers to a film that shrinks at least 10% in at least one of the longitudinal and transverse directions when heated at 90° C. for 4 seconds. The shrinkability is measured according to ASTM 2732. This test method covers the determination of the degree of unrestrained linear thermal shrinkage at given specimen temperatures of a plastic film and sheeting of 0.76 mm thickness or less.

All measurement methods mentioned herein are readily available for the skilled person. For example, they can be obtained from the American National Standards Institute at: www.webstore.ansi.org

The phrase “longitudinal direction” or “machine direction” herein abbreviated “MD” refers to a direction along the length of the film.

The phrase “outside layer” refers to the film layer which comes in immediate contact with the outside environment (atmosphere).

The phrase “inner layer” refers to the film layer that comes in direct contact with the product packed. This is also called “sealing layer” as this layer must be hermetically sealed in order to protect the product from ingress of air.

As used herein, the term “homopolymer” refers to a polymer resulting from polymerization of a single monomer.

As used herein, the term “copolymer” refers to a polymer resulting from polymerization of at least two different polymers.

As used herein, the term “polymer” includes both above types.

As used herein the term “polyethylene” identifies polymers consisting essentially of the ethylene repeating unit. The ones that have a density more than 0.940 are called high density polyethylene (HDPE), the ones that are have less than 0.940 are low density polyethylene (LDPE).

As used herein the phrase “ethylene alpha olefin copolymer” refers to polymers like linear low density polyethylene (LLDPE), medium density polyethylene (MDPE), very low density polyethylene (VLDPE), ultra low density polyethylene (ULDPE), metallocene catalysed polymers and polyethylene plastomers and elastomers.

As used herein the phrase “styrene polymers” refers to styrene homopolymer such as polystyrene and to styrene copolymers such as styrene-butadiene copolymers, styrene-butadiene-styrene copolymers, styrene-isoprene-styrene copolymers, styrene-ethylene-butadiene-styrene copolymers, ethylene-styrene copolymers and the like.

As used herein the phrase “ethylene methacrylate copolymers” refers to copolymers of ethylene and methacrylate monomer. The monomer content is preferably less than 40%.

As used herein the phrase “ethylene vinyl acetate copolymer” refer to copolymers of ethylene and vinyl acetate.

As used herein, the term EVOH refers to saponified products of ethylene vinyl ester copolymers. The ethylene content is typically in the range of 25 to 50%.

As used herein the term PVDC refers to a vinylidene chloride copolymer wherein a major amount of the copolymer comprises vinylidene chloride and a minor amount of the copolymer comprises one or more monomers such as vinyl chloride and/or alkyl acrylates and methacrylates.

As used herein the term polyamide refers to homopolymers and copolymers.

As used herein the term “polypropylene” refers to any homopolymer, copolymer, terpolymer, tetrapolymer etc. that includes mer units of propylene. The term as used in the present application includes homopolymers, random copolymers, propylene alpha olefin copolymers, propylene ethylene copolymers propylene-ethylene-alpha olefin copolymers and other propylene polymers.

### DETAILED DESCRIPTION

The heat sealing layer of the multilayer film of the present invention comprising a polypropylene (PP) homopolymer or copolymer has a vicat softening point of less than 105° C. measured under ASTM D 1525.

PP might be present as a heterogeneous or a homogeneous polymer produced with single site catalyst. It may also be a blend of such a material with following
1. another PP polymer such as random copolymer or homopolymer (among others)
2. a polyethylene polymer such as an alpha olefin copolymer with density 0.860 to about 0.960 or such as an ethylene ester copolymer
3. a cyclic olefin copolymer
4. a styrene polymer
5. an ionomer or a methacrylic acid copolymer
6. polybutene polymer

In a preferred case, the vicat softening point of the heat sealing layer is less than 100° C. As mentioned above, this is an unexpected effect, as the vicat softening point of the polymer is so close to the actual thermal conditions that the material is subjected (going up to 95° C.).

The Vicat softening point is the determination of the softening point for materials such as polypropylene or polyethylene, which have no definite melting point. It is taken as the temperature at which the specimen is penetrated to a specified depth by a flat-ended needle with a defined circular or square cross-section, under a specified load.

The oxygen barrier used may be a material such as a polyvinylidene chloride homopolymer or copolymer or an ethylene vinyl alcohol copolymer (EVOH). Other oxygen barrier materials are also well known in the art. As example, oxygen barrier materials, also polyamides or polyesters may be used.

In the outside layer the following materials may be used
1. a polypropylene homopolymer or copolymer having a vicat softening point of less than 105° C. measured under ASTM D 1525. It is preferably a homogeneous polymer produced with single site catalyst,
2. PP polymer such as random copolymer or homopolymer (among others)
2. Polyethylene polymer such as an alpha olefin copolymer with density 0.860 to about 0.960 or such as an ethylene ester copolymer
3. a cyclic olefin copolymer
4. a styrene polymer
5. an ionomer or a methacrylic acid copolymer

A preferred version comprises a
1. styrene butadiene copolymer
2. a blend of styrene butadiene copolymer and an ethylene alpha olefin copolymer

Between the inner heat sealing layer and the oxygen barrier layer may exist further layers that could comprise any of the polymers mentioned in the possibilities for inner heat sealing layer. Preferred materials are ethylene vinyl acetate, ethylene alpha olefin copolymers, EMA polymers, polypropylene copolymers, polybutylene, styrene homopolymers or copolymers.

Any of the layers described above may also include additives well known in the art such as slip agents, antiblock, polymer processing aids, antistatic, antifog, acid scavengers, odour scavengers and the like. A person skilled in the art may select the right additives according to any particular needs.

In a preferred version of the application, the film is irradiated with e beam radiation of levels from 1 to 10 MRAD.

### EXAMPLES

A 5 layer film is produced in a double bubble (the double bubble method is described in U.S. Pat. No. 3,456,044, incorporated herein by reference) commercial line with the following structure:

| | |
|---|---|
| Inner (sealing) layer, | 100% PP1 |
| Adjacent layer | 93% E1 + 7% ADDITIVES |
| Barrier layer | PVDC commercial grade |
| Adjacent layer | 30% M1 + 65% E3 + 5% ADDITIVES |
| Outer layer | 95% S1 + 5% ADDITIVES |

See table 1,2

A 5 layer film is produced in a double bubble (the double bubble method is described in U.S. Pat. No. 3,456,044) commercial line with the following recipe

| | |
|---|---|
| Inner(sealing layer), | 80% PP1 + 20% PP2 |
| Adjacent layer | 93% E1 + 7% ADDITIVES |
| Barrier layer | PVDC commercial grade |
| Adjacent layer | 30% MI + 65% E3 + 5% ADDITIVES |
| Outer layer | 95% S1 + 5% ADDITIVES |

A 5 layer film is produced in a double bubble (the double bubble method is described in U.S. Pat. No. 3,456,044) commercial line with the following recipe

| | |
|---|---|
| Inner(sealing layer), | 100% PP3 |
| Adjacent layer | 93% E1 + 7% ADDITIVES |
| Barrier layer | PVDC commercial grade |
| Adjacent layer | 30% M1 + 65% E3 + 5% ADDITIVES |
| Outer layer | 95% S1 + 5% ADDITIVES |

See table 1, 2

In all the above examples, the thickness of the layers are (in microns)
8, outer layer
10, adjacent layer
4, barrier layer
6, adjacent layer
27, heat sealing layer

### Comparative Example

Under exactly the same conditions a commercial product FMXBK was produced.

All the samples were e-beam radiated with a dose of 4 MRAD prior to bag making.

TABLE 1

| | | | Melt | | Melting |
|---|---|---|---|---|---|
| | | | Index | Density | point |
| Type | Description | Manufacturer | g/10 min | g/cm³ | ° C. |
| E1 | EVA | Dupont 3135 X | 0.35 | 0.93 | 95 |
| E2 | EVA | 1005 VN2 | 0.40 | 0.928 | 102 |
| E3 | EVA | Dupont 3165 | 0.7 | 0.94 | 89 |
| S1 | SB | DK13 | 10 | 1.01 | |
| | COPOLYMER | | | | |
| M1 | EMA | ARKEMA | 2-3,5 | 0,95 | 61 |
| | copolymer | LOTRYL | | | |
| | | 29MA03 | | | |

TABLE 2

| | | Vicat |
|---|---|---|
| | | softening |
| Type | Description | point |
| PP1 | PP copolymer | Approx. 95 |
| PP2 | RB707CF | 125 |
| PP3 | PP ethylene | 91 |
| | alpha olefin | |
| | copolymer | |

TABLE 3

| | HAZE | GLOSS | SHRINKAGE (MD/TD) |
|---|---|---|---|
| Example 1 | 6 | 102 | 42/42 |
| Example 2 | 7 | 101 | 38/37 |
| Example 3 | 7 | 99 | 41/41 |
| Comparison | 8 | 90 | 49/45 |

Haze is measured according to ASTM D 1003, gloss according to BS 2782 and shrinkage according to ASTM 2732.

For better evaluation of the resistance of the sealing properties under cook-in conditions, the following experiment was executed.

Material from samples 1, 2, 3, and comparative sample were made into bag configuration in a pouch making machine. Then the bags were filled with water and sealed at the open end. Then the bags were put in a hot water bath and cooked at 95 C for 5 hours. After this thermal treatment, the bags were examined if their seals were destroyed and if delamination was noticed.

TABLE 4
11/22 Results of cook-in test

| | |
|---|---|
| Example 1 | No bag opened |
| Example 2 | No bag opened |
| Example 3 | No bag opened |
| Comparison | All bags opened |

1. A heat shrinkable film comprising a sealing layer containing a polypropylene polymer, the sealing layer as well as the polypropylene polymer having a vicat softening point of less than 105° C., preferably less than 100° C., measured according to ASTM D 1525.

2. The film of claim 1, wherein the film comprises at least the sealing layer as an inner layer, a barrier layer and an outer layer.

3. The film according to claim 1 or 2, where the film comprises an adjacent layer which may comprise an ethylene vinyl acetate copolymer and/or an ethylene alpha olefin copolymer.

4. The film according to one or more of the preceding claims, where the sealing layer further comprises a material selected from another polypropylene polymer, ethylene alpha olefin and polybutene polymers, cyclic olefin polymer, ionomer, styrene polymer and/or methacrylic acid copolymer.

5. The film according to any of the preceding claims, where the film comprises a barrier layer incorporating a high oxygen barrier material, such as EVOH, PVDC or polyamide.

6. The film according to any of the preceding claims where the film comprises an outside layer incorporating
a polypropylene polymer
an ethylene alpha olefin copolymer
a styrene butadiene polymer
a polyamide
a polybutene and/or
an EVOH polymer.

7. The film according to any of the preceding claims incorporating between the outside and barrier as well as between sealing and barrier other layers incorporating other polymers.

8. The film according to any of the preceding claims where the film is irradiated.

9. The film according to any of the preceding claims having a flat or tubular form.

10. A bag or pouch made by the film of one or more of claims 1-9.

11. A method of packaging and preserving a food product, comprising the steps of:
a) providing a film as defined in one or more of claims 1-9 or a bag or pouch as defined in claim 10, and a food product;
b) packaging the food product into said film, bag or pouch;
c) subjecting the packaged food product to an elevated temperature for a predefined time thereby preserving the food product.

12. The method of claim 11, wherein the elevated temperature is in a range of between 70-98° C., preferably 95° C.

13. The method of claim 12, wherein the time period for subjecting the packaged food product to an elevated temperature is between 1 and 18 hours.

14. The method of one or more of claims 11-13, wherein the packaged food product is subjected to an elevated temperature by immersing in hot water.

15. A packaged food product obtainable by the method of claims 11-14.
